(19) United States
(12) Patent Application Publication
(10) Pub. No.: US 2008/0058020 A1
(43) Pub. Date: Mar. 6, 2008

(54) Mobile Device with Display Device and Image Acquisition Unit

(75) Inventor: Erik Boudewijn Van Der Tol, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V.

(21) Appl. No.: 10/565,930

(22) PCT Filed: Jul. 14, 2004
(86) PCT No.: PCT/IB04/51217

§ 371 Date: Jan. 20, 2006

(30) Foreign Application Priority Data
Jul. 24, 2003 (EP) 03102273.4

(51) Int. Cl. H04B 1/38; H04M 1/00

(52) U.S. Cl. 455/566

(57) ABSTRACT

A mobile device (200) is comprising: a display device (102) for displaying a number of display images of a sequence of display images, during a predetermined amount of time; and an energy resource (116) for providing the display device (102) with energy, is disclosed. The mobile device (200) further comprises energy management means for estimating an amount of available energy of the energy resource and control means (114) for controlling the number of display images on basis of the amount of available energy. Additionally the mobile device comprises an image acquisition unit, like for instance a camera.

The invention relates to a mobile device comprising:

a display device for displaying a number of display images of a sequence of display images, during a predetermined amount of time; and

an energy resource for providing the display device with energy.

The advent of mobile communication devices with integrated camera functionality gives rise to many new applications in the area of mobile communication. A first example of this is MMS (Multimedia Messaging Service), which provides a means of transmitting pictorial data to and from mobile devices. A second example is exchange of sequences of images to be displayed on the mobile device. Displaying these sequences with an appropriate display frequency results into nice motion portrayal. The sequences of images might be recorded by the integrated camera of the mobile device, received via broadcast, multicast or unicast or imported by means of removable storage devices.

A mobile device needs energy for its operation. This energy is provided by means of an energy resource, e.g. a battery or fuel cell. The quality of mobile energy resources is increasing, i.e. the physical dimension per stored amount of energy is decreasing and the accumulation time required for storage of a predetermined amount of energy is decreasing. However, energy consumption is still an important issue for mobile devices.

It is an object of the invention to provide a mobile device of the kind described in the opening paragraph which is arranged to make a trade-off between energy consumption and perceived image quality.

This object of the invention is achieved in that that the mobile device further comprises energy management means for estimating an amount of available energy of the energy resource and control means for controlling the number of display images per time unit on basis of the amount of available energy. Motion portrayal is an important aspect of perceived image quality. In general, the number of different images being displayed per predetermined amount of time, e.g. per second, should be as high as feasible. However, a relatively large amount of energy is required in order to display different images. Hence, the mobile device according to the invention comprises means to control the number of different display images in order to prevent that, regarding to the actually available amount of energy, too much energy is wasted for displaying images. That means that a trade-off between energy consumption and perceived image quality is made.

An embodiment of the mobile device according to the invention comprises an image acquisition unit for acquisition of a further number of input images during the predetermined amount of time, the display images being based on the input images. The display images might be based on input images being received, but in this embodiment according to the invention the display image can also be based on input images which are acquired by means of the mobile device itself. The mobile device comprises an image acquisition unit for this purpose. The image acquisition unit comprises optical means like a lens and an images sensor, e.g. a CCD or CMOS. The display device of the mobile device is optionally used as a so-called view finder. That means that the momentary acquired input images are transferred to the display device in order to support the user of the mobile device to pan to a satisfactory view. The transfer optionally comprises image processing, e.g. to increase the spatial resolution, or to enhance the color or luminance contrast between the pixels of the respective display images.

An embodiment of the mobile device according to the invention comprising the image acquisition unit is characterized in that the control means are arranged to control the further number of input images, being acquired by the image acquisition unit, on basis of the amount of available energy. Suppose that the number of acquired input images per second and the number of display images are mutually equal. Then a reduction of the number of acquired input images per second has a relatively large effect on the energy consumption, because several units of the mobile device are operating with a reduced speed, e.g. the image acquisition unit, internal communication means like a data-bus, processing means for image processing and the display device.

An embodiment of the mobile device according to the invention comprises an interpolation unit for computing the display images on basis of respective input images. Preferably the control means are arranged to control the ratio between the further number of the input images and the number of the display images, on basis of the amount of available energy. Alternative to or optionally in combination with the control of the number of acquired images this embodiment according to the invention is arranged to control the number of display images by means of computing additional images on basis of interpolation of input images. This is called temporal up-conversion and is typically performed by means of a temporal up-conversion unit. The inventor has proven that in many cases the computation of additional images requires less energy than the acquisition of additional images. In other words, capturing image data by means of a sensor often costs more energy than the computation of image data by means of interpolation.

An embodiment of the mobile device according to the invention comprises user interface means to control the control means to make a trade-off between control of the image acquisition unit and the interpolation unit. Although motion compensated up-conversion might result in satisfactory results, the acquisition of additional images is in most cases better from the perspective of image quality. A reason is that computed intermediate images are in many cases less sharp because these images are based on interpolation of multiple values. By means of the user interface the user of the mobile device is e.g. enabled to choose between increasing the number of display images by increasing the acquisition frequency or by increasing the up-conversion ratio.

An embodiment of the mobile device according to the invention comprises communication means for exchange of data with other devices. That data optionally corresponds to input images on which the display images are based. Alternatively the data corresponds to audio or other information. The mobile device might be a camera, a mobile telephone or videophone, a laptop or a PDA (personal digital assistant).

These and other aspects of the mobile device according to the invention will become apparent from and will be elucidated with respect to the implementations and embodiments described hereinafter and with reference to the accompanying drawings, wherein:

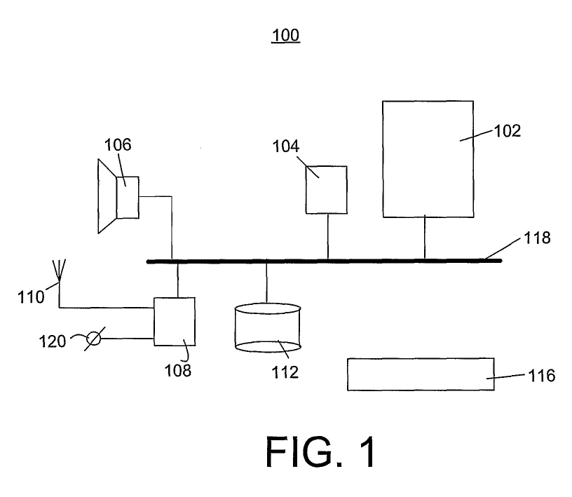

FIG. 1 schematically shows a mobile device comprising an image sensor, a display device and an up-conversion unit; and

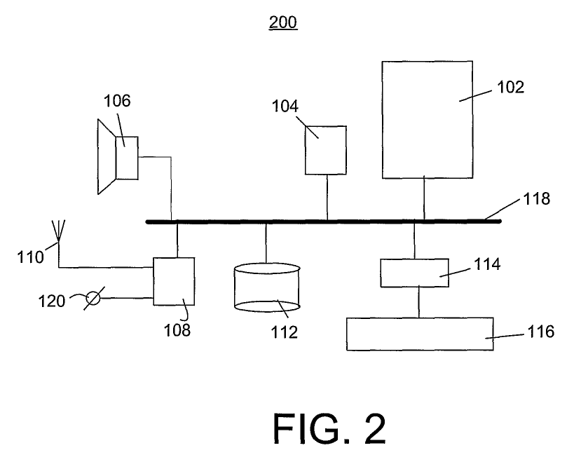

FIG. 2 schematically shows the mobile device of FIG. I further comprising an energy management unit. Same reference numerals are used to denote similar parts throughout the Figures.

FIG. 1 schematically shows a mobile device having image processing capabilities. The mobile device 100 comprises:
an integrated camera 106 for acquisition of a sequence of input images. This camera includes a lens and a solid state image sensor, e.g. CCD or CMOS;
a display device 102 for displaying a sequence of display image. This display device is e.g. a LCD or LED display;
an image processing unit 104 being arranged to transform the sequence of input images into the sequence of display images. This transformation comprises a temporal up-conversion. That means that on basis of a first number of input images a second number of display images is computed by means of temporal interpolation, with the second number of images being higher than the first number of images. The transformation optionally includes spatial scaling and/or spatial enhancement;
a memory device 112 for temporarily storage of images. This memory device 112 might be a solid state device, e.g. compact flash or a disk based device e.g. SFFO disks. Optionally a part of the memory device 112 is removable;
a data exchange unit 108 for data exchange with other devices. This data exchange might be based on transmission and reception by means of an antenna 110 or by means of a physical connection to the connector 120;
internal data exchange means, e.g. a data bus 118. Optionally, some of the units and devices of the mobile device have additional direct connections to each other. For example a direct connection between the image processing unit 104 and the display device 102 is advantageous; and
an energy resource 116 providing energy to other parts of the mobile device. It will be clear that the energy resource 116 is connected to these other parts of the mobile device. These connections are not depicted. The energy resource is e.g. a battery or fuel cell.

This mobile device 100 is arranged to acquire input images and to transmit these input images to other devices. In order to determine whether the appropriate input images are and/or will be acquired, the user is provided with display images which are related to the acquired input images. That means that the mobile device can operate in a so-called viewfinder mode.

An important function of the mobile device 100 is the temporal up-conversion of input images into display images. Temporal up-conversion, or picture rate conversion is e.g. disclosed in chapter 4 of the book “Video processing for multimedia systems”, by G. de Haan (ISBN: 90-9014015-, Eindhoven September 2000). Preferably, the up-conversion is motion compensated in order to get smooth motion portrayal. In section 4.3.1 of the cited book is a motion compensated picture repetition method disclosed which results in a minimum latency. For view finding this type of up-conversion is preferred.

Next some scenarios are discussed related to the control of the stream of image data from the acquisition, i.e. the integrated camera 106, to the display device 102. Suppose that the integrated camera 106 acquires input images with an acquisition frequency f_{A} of e.g. 15 images per second. These input images are optionally processed and then a sequence of display images is provided to the display device 102. Each image of the sequence of display images is derived from a respective image of the sequence of input images. Hence, the display device 102 is displaying the sequence of display images with a display frequency of f_{D} of 15 images per second. Assume that the motion detection unit or motion estimation unit, which is implemented in the image processing unit 104 determines that the subsequent input images of the sequence of input image are substantially mutually equal. That means that differences between the subsequent images are primarily based on noise. Then the integrated camera 106 is informed about this fact. As a consequence the integrated camera 106 reduces his acquisition frequency f_{A} to e.g. 5 images per second. In order to remain at the display frequency f_{D} of 15 images per second, the image processing unit 104 computes additional display images on basis of the acquired input images.

Alternatively, the motion detection unit or motion estimation unit determines that there is a substantial amount of motion. In that case the display frequency f_{D} might be too low for a nice motion portrayal. Then a display frequency f_{D} which is higher than 15 images per second, e.g. 25 or 50 images per second, is required. Without increasing the acquisition frequency f_{A} this is achieved by means of temporal interpolation being performed by the image processing unit 104. In other words, on basis of the sequence of input images, comprising 15 input images belonging to a time period of 1 second, a sequence of display images is computed comprising e.g. 25 display images belonging to the time period of 1 second.

It will be clear that also images which are received by means of the data exchange unit 108 might be provided to the up-conversion unit, being implemented by the image processing unit 104, in order to compute an extended sequence of display images.

To summarize. In connection with FIG. 1 is described that the following three components are controlled regarding to the amount of images:
the integrated camera 106, to adjust the acquisition frequency f_{A} of input images;
the up-conversion unit, being implemented in the image processing unit 104, to control the ratio between the number of the input images and the number of the display images; and
the display device 102, to control the display frequency f_{D} of display images. In general, the number of display images per second is equal to the number of images being computed by the up-conversion unit or the number of images being acquired by means of the integrated camera 106.

The control is based on comparing image content, e.g. motion detection or motion estimation of the acquired input images. Optionally the control is based on the input of the user. Therefore the mobile device optionally comprises a user interface to control the mobile device to make a trade-off between control of the image acquisition unit and the interpolation unit. The user can e.g. choose between high perceived image quality, moderate perceived image quality and low perceived image quality corresponding to respective amounts of energy consumption.

Alternatively the control is based on the available amount of energy. FIG. 2 schematically shows the mobile device of FIG. 1, further comprising an energy management unit 114. The energy management unit 114 is informed about the estimated amount of energy currently available in the energy resource 116. On basis of the estimated amount of energy the energy management unit 114 provides different control signals to other parts of the mobile device, e.g. the integrated camera 106, the image processing unit 104 and the display device 102. For example the following cases can be distinguished:

- In the case of a relatively high energy level, i.e. amount of energy currently available, the display frequency f_{D} might be relatively high, e.g. 25 or 50 mages per second. Also the acquisition frequency f_{A} might be relatively high in that case, even equal to the display frequency f_{D}.

In the case of an average energy level, the display frequency f_{D} could be moderate, e.g. 15 images per second. The acquisition frequency f_{A} might be equal to display frequency f_{D} but preferably the acquisition frequency f_{A} is lower than the display frequency f_{D}, e.g. reduced to e.g.8 images per second.

In the case of a relatively low energy level, the display frequency f_{D} should be relatively low, e.g. 5 or 10 images per second. The acquisition frequency f_{A} might be even lower then the display frequency f_{D}.

It will be clear that the control of the integrated camera 106, the image processing unit 104 and the display device 102 might differ from what is described in these examples. Other combinations of the acquisition frequency f_{A} and the display frequency f_{D} are also possible for different energy levels.

It should be noted that the above-mentioned embodiments illustrate rather than limit the invention and that those skilled in the art will be able to design alternative embodiments without departing from the scope of the appended claims. In the claims, any reference signs placed between parentheses shall not be constructed as limiting the claim. The word ‘comprising’ does not exclude the presence of elements or steps not listed in a claim. The word “a” or “an” preceding an element does not exclude the presence of a plurality of such elements. The invention can be implemented by means of hardware comprising several distinct elements and by means of a suitable programmed computer. In the unit claims enumerating several means, several of these means can be embodied by one and the same item of hardware.

1. A mobile device (200) comprising:
a display device (102) for displaying a number of display images of a sequence of display images, during a predetermined amount of time; and
an energy resource (116) for providing the display device (102) with energy, characterized in that the mobile device (200) further comprises energy management means for estimating an amount of available energy of the energy resource and control means (114) for controlling the number of display images on basis of the amount of available energy.

2. A mobile device (200) as claimed in claim 1, characterized in that the mobile device (200) comprises an image acquisition unit (106) .for acquisition of a further number of input images during the predetermined amount of time, the display images being based on the input images.

3. A mobile device (200) as claimed in claim 2, characterized in that the control means (114) are arranged to control the further number of input images, being acquired by the image acquisition unit (106), on basis of the amount of available energy.

4. A mobile device (200) as claimed in claim 2, characterized in that it comprises an interpolation unit (104) for computing the display images on basis of respective input images.

5. A mobile device (200) as claimed in claim 4, characterized in that the control means (114) are arranged to control the ratio between the further number of the input images and the number of the display images, on basis of the amount of available energy.

6. A mobile device (200) as claimed in claim 4, characterized in that the interpolation unit (104) is a temporal up-conversion unit.

7. A mobile device (200) as claimed in claim 4, characterized in that the mobile device (200) comprises user interface means to control the control means (114) to make a trade-off between control of the image acquisition unit (106) and the interpolation unit (104).

8. A mobile device (200) as claimed in claim 4, characterized in that the control means (114) are arranged to control the ratio between the further number of the input images and the number of the display images, on basis of a motion signal being derived from the input images.

9. A mobile device (200) as claimed as claimed in claim 1, characterized in comprising communication means for exchange of data with other devices.

10. A mobile device (200) as claimed as claimed in claim 9, characterized in that the data corresponds to input images on which the display images are based.
